(19) United States
(12) Patent Application Publication
(10) Pub. No.: US 2016/0075227 A1
(43) Pub. Date: Mar. 17, 2016

(54) Automotive fuel tank

(71) Applicant: Yu-Peng Chan, Changhua (TW)

(72) Inventor: Yu-Peng Chan, Changhua (TW)

(21) Appl. No.: 14/953,405

(22) Filed: Nov. 29, 2015

(51) Int. Cl. B60K 15/03; B60K 15/04; B60K 15/01

(52) U.S. Cl. CPC B60K 15/03; B60K 15/01; B60K 15/04

(57) ABSTRACT

An automotive fuel tank is described and includes an upper shell including an opening and a flexible, protruding bottom edge; a filling pipe secured to the opening; and a lower shell including a flexible, protruding top edge secured to the bottom edge. The automotive fuel tank can withstand collision without causing cracks.

### BACKGROUND OF THE INVENTION

1. Field of the Invention

The invention relates to fuel tanks and more particularly to an automotive fuel tank having improved characteristics.

2. Description of Related Art

A conventional automotive fuel tank A is shown in FIG. 1 in which resin B is applied to a joining portion of a filling pipe and the fuel tank A. However, cracks A1 can be caused on the fuel tank A after a period of time of use due to low structural strength of the fuel tank A.

Thus, the need for improvement still exists.

### SUMMARY OF THE INVENTION

It is therefore one object of the invention to provide an automotive fuel tank comprising an upper shell including an opening and a flexible, protruding bottom edge; a filling pipe secured to the opening; and a lower shell including a flexible, protruding top edge secured to the bottom edge.

The above and other objects, features and advantages of the invention will become apparent from the following detailed description taken with the accompanying drawings.

### BRIEF DESCRIPTION OF THE DRAWINGS

FIG. 1 is a perspective view of a conventional automotive fuel tank;

FIG. 2 is an exploded view of an automotive fuel tank according to the invention;

FIG. 3 is a perspective view of the assembled automotive fuel tank of FIG. 2 with a filling pipe secured thereto;

FIG. 4 is a sectional view taken along line 4-4 of FIG. 3;

FIG. 5 is a view similar to FIG. 4 showing the bottom edges and the top edges being bent; and

FIG. 6 is a view similar to FIG. 5 showing the fuel tank mounted in an automobile.

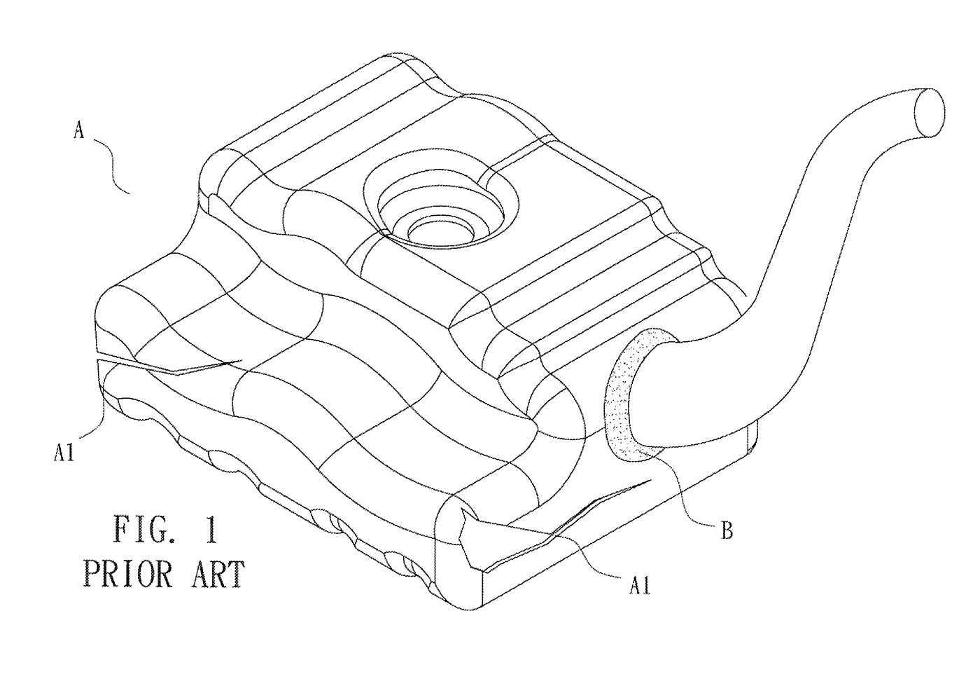

### DETAILED DESCRIPTION OF THE INVENTION

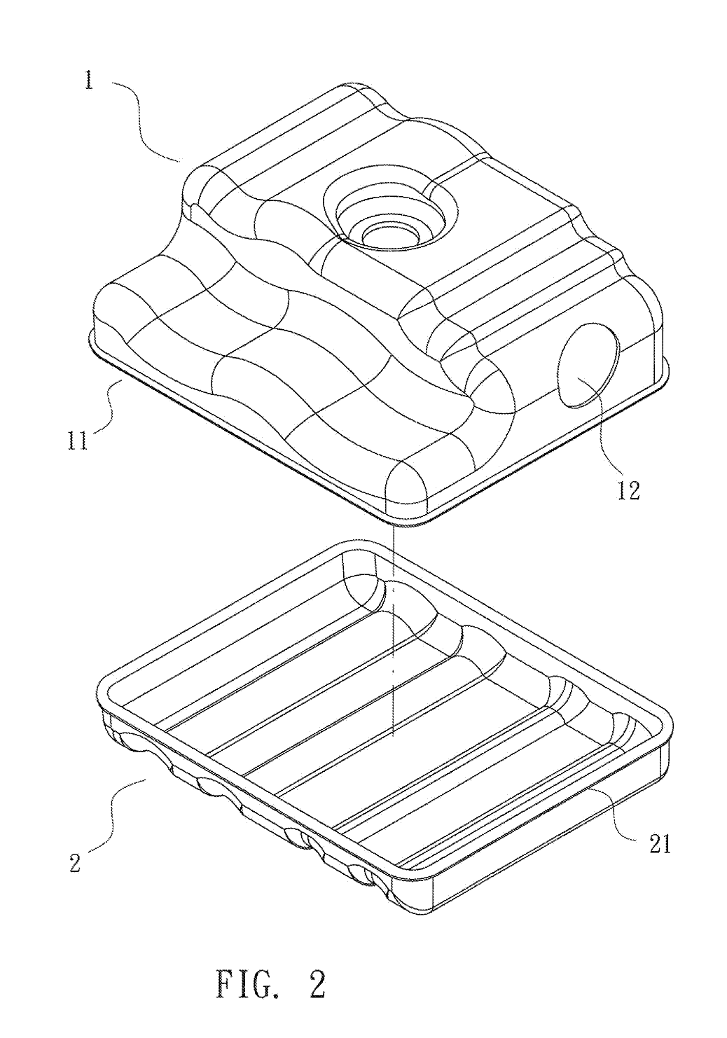

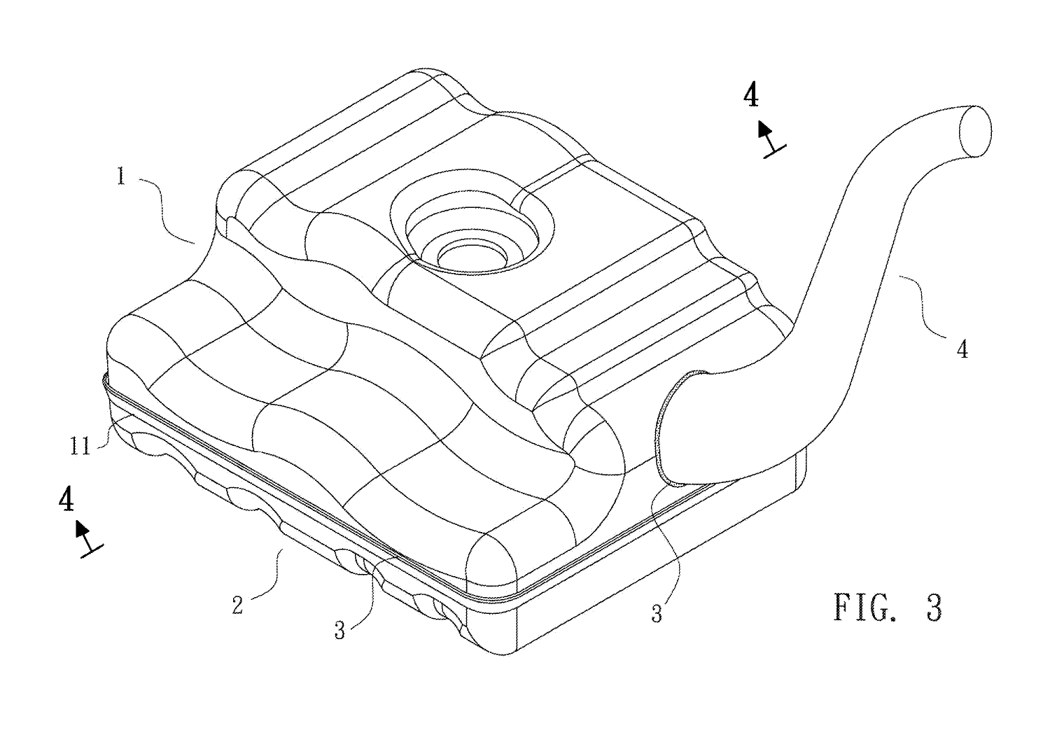

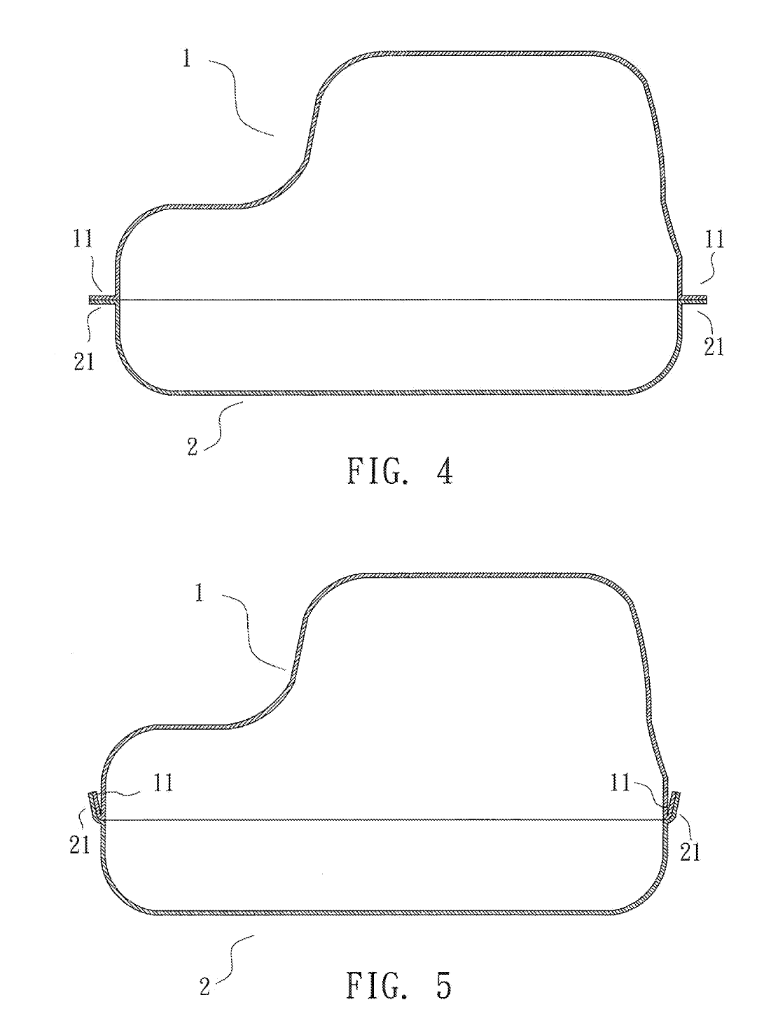

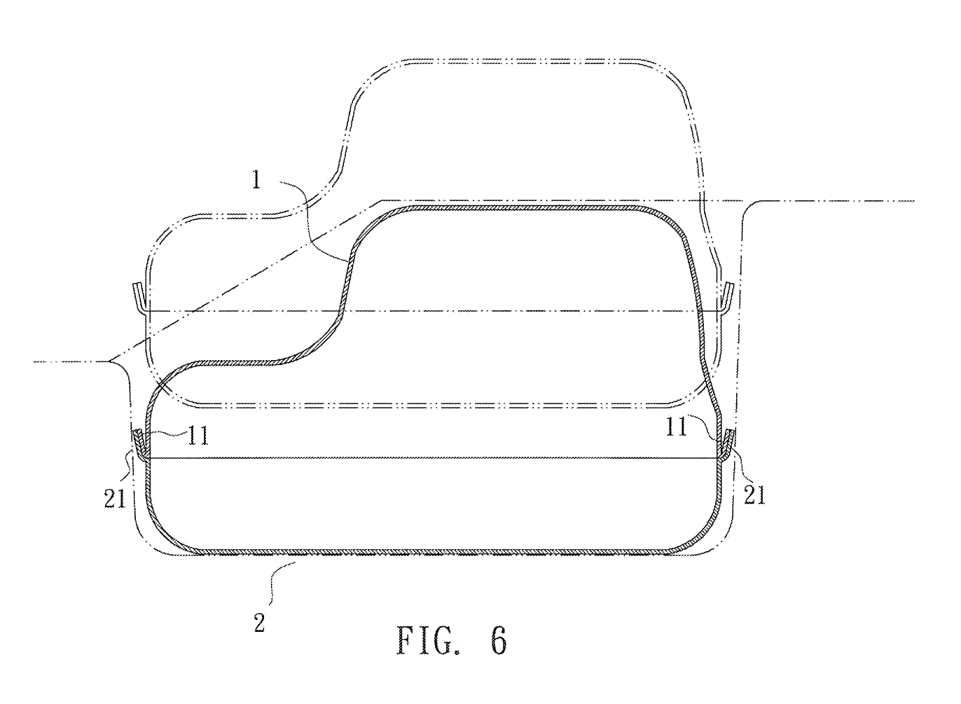

Referring to FIGS. 2 to 6, an automotive fuel tank in accordance with the invention comprises an upper shell 1 including a flexible, protruding bottom edge 11 and an opening 12; and a lower shell 2 including a flexible, protruding top edge 21. The bottom edge 11 and the top edge 21 are secured together by applying solder 3 thereon. Further, the opening 12 and a filling pipe 4 are secured together by applying solder 3 thereon. The assembled fuel tank can be mounted in an automobile by bending the bottom edge 11 and the top edge 21.

It is envisaged by the invention that the automotive fuel tank is structurally strong and can withstand collision without causing cracks.

While the invention has been described in terms of preferred embodiments, those skilled in the art will recognize that the invention can be practiced with modifications within the spirit and scope of the appended claims.

What is claimed is:

1. An automotive fuel tank comprising:
an upper shell including an opening and a flexible, protruding bottom edge;
a filling pipe secured to the opening; and
a lower shell including a flexible, protruding top edge secured to the bottom edge.
